(19) United States
(12) Patent Application Publication
(10) Pub. No.: US 2020/0043492 A1
(43) Pub. Date: Feb. 6, 2020

(54) SPEECH RECOGNITION METHOD AND APPARATUS

(71) Applicant: LG ELECTRONICS INC., Seoul (KR)

(72) Inventors: Ye Jin KIM, Seoul (KR); Ye Kyung KIM, Seongnam-si (KR); Gyeong Hun KIM, Seongnam-si (KR)

(73) Assignee: LG ELECTRONICS INC., Seoul (KR)

(21) Appl. No.: 16/598,906

(22) Filed: Oct. 10, 2019

(30) Foreign Application Priority Data
May 21, 2019 (KR) 10-2019-0059384

(51) Int. Cl. G10L 15/22; G10L 15/08; G10L 15/30

(52) U.S. Cl. CPC G10L 15/22; G10L 15/08; G10L 2015/223; G10L 2015/088; G10L 15/30

(57) ABSTRACT

Disclosed are a speech recognition apparatus for speech recognition, and a method therefor. A speech recognition method for speech recognition includes detecting an event during a first spoken utterance, transmitting a suspension request signal requesting suspension of signal processing for the first spoken utterance at the point in time when the event is detected, and waiting for recognition of a second spoken utterance. According to the present disclosure, by canceling an erroneously spoken utterance through 5G network service and AI algorithm, a speech recognition process can proceed rapidly.

### CROSS-REFERENCE TO RELATED APPLICATION

Pursuant to 35 U.S.C. § 119(a), this application claims the benefit of earlier filing date and right of priority to Korean Patent Application No. 10-2019-0059384, filed on May 21, 2019, the contents of which are hereby incorporated by reference herein in its entirety.

### BACKGROUND

### 1. Technical Field

The present disclosure relates to an apparatus and method of input and output for speech recognition. More particularly, the present disclosure relates to an apparatus and method for processing speech input and output for a speech recognition service in an artificial intelligence (AI) speaker and various smart electronic devices.

### 2. Description of Related Art

In accordance with the popularization of smartphones, speech recognition technology, which enables a machine to comprehend human speech, has come into the spotlight as a key human-centric interface for the future. Based on speech recognition technology, and including natural language processing and knowledge processing, speech recognition services are being developed to understand human speech and converse with humans. In addition, it is expected that new integrated services will be provided in various fields, such as medicine, education, culture, automobiles, shipbuilding, defense, IoT, and robots, in the future.

A smart speaker may be the most familiar speech recognition apparatus. As a type of wireless speaker, a smart speaker is a voice command device having a virtual assistant embedded therein, which provides interactive actions and hands-free activation with the help of a wake-up word.

Some smart speakers may serve as a personal assistant through functions of speech recognition and natural language processing, and may be used to control smart home devices by using Bluetooth™ and other wireless protocol standards.

In the same manner as cancellation of an utterance during a conversation between humans, a user may have to cancel a spoken utterance even when interacting with a smart speaker. In this case, in the conventional art, the operation of the smart speaker may be delayed if the user momentarily speaks an utterance such as “or,” that is beyond a recognition range of the smart speaker.

Japanese Patent Laid-open Publication No. 2018-116206 (hereinafter, referred to as “related art 1”) discloses a speech recognition system capable of canceling a control operation executed in response to erroneously recognized speech.

However, when a spoken utterance is erroneously recognized and a control instruction is executed in response to the erroneously recognized speech, new utterance processing should be executed for cancellation of the control instruction. Thus, the speech recognition can be delayed in related art 1.

Japanese Patent Publication No. 2019-020589 (hereinafter, referred to as “related art 2”) discloses a speech recognition system capable of canceling a stop instruction when the operation of a machine has suspended due to erroneously recognized speech.

However, cancelling the stop instruction requires a new utterance, and thus, related art 2 still cannot solve the conventional problem of the delay in speech recognition.

FIG. 1 is an exemplary view of a reutterance process for canceling a spoken utterance in the related art.

Referring to FIG. 1, a conversation between a user and a smart speaker, namely an AI speaker, is illustrated. The user starts a conversation with the smart speaker by speaking a wake-up word of “Hi, LG.” The smart speaker is activated though recognition of the wake-up word.

Next, the user speaks a first spoken utterance, and then proceeds to speak another utterance intended to cancel the first spoken utterance, such as “Turn on the TV . . . no . . . ignore that.” In response to this, the smart speaker fails to recognize the content, and replies with, for example, “Sorry, I missed that” or “Could you say that again?” The user then speaks a second spoken utterance of “Switch to away mode,” and the smart speaker then recognizes the second spoken utterance of the user through audio processing, and replies.

As described above, there is no effective method in the conventional technology for cancelling an utterance in a conversation between the user and the smart speaker, and thus, there has been considerable time delay in recognition of the second utterance.

### RELATED ART DOCUMENT

### Patent Document

Japanese Patent Laid-open Publication No. 2018-116206 (Jul. 26, 2018)

Japanese Patent Laid-open Publication No. 2019-020589 (Feb. 7, 2019)

The information disclosed in this Background section is only for enhancement of understanding of the general background of the disclosure and therefore it may contain information that does not form the prior art that is already known to a person skilled in the art.

### SUMMARY OF THE INVENTION

The present disclose is directed to solving the problem in the conventional technology of delay of speech recognition due to processing of another spoken utterance to cancel a previously spoken utterance.

The present disclosure is directed to providing a speech recognition method capable of canceling an erroneously spoken utterance before the erroneously spoken utterance is processed.

It will be appreciated that aspects to be achieved by the present disclosure are not limited to what has been disclosed hereinabove and other aspects will be more clearly understood from the following exemplary embodiments. Further, it will be readily appreciated that the objectives and advantages of the present disclosure may be realized by features and combinations thereof as disclosed in the claims.

In order to achieve the aforementioned aspects, a speech recognition method according to an exemplary embodiment of the present disclosure may be configured to comprise detecting an event based on audio received following a first spoken utterance, determining whether signal processing has been completed for the first spoken utterance when the event is detected, transmitting a suspension request signal requesting suspension of signal processing for the first spoken utterance based on a determination that the signal processing has not been completed, and switching to a mode for detecting a second spoken utterance based on confirmation that the signal processing for the first spoken utterance has been suspended.

In addition, the event comprises an utterance that is distinct from a wake-up word.

In addition, the event comprises a sound having a specific frequency range.

In addition, the signal processing comprises speech recognition, natural language understanding, natural language generation, and speech synthesis, and the suspension request signal corresponds to a signal requesting suspension of at least one of the speech recognition, natural language understanding, natural language generation, or speech synthesis.

In addition, the event to be detected for suspending signal processing is designated by a user.

In addition, an audio signal corresponding to the detected event is not transmitted to a speech processing system.

In addition, the method further comprises receiving a confirmation message confirming that signal processing for the first spoken utterance has been suspended.

In addition, the method further comprises outputting a notification that the signal processing for the first spoken utterance has been suspended, and requesting the second spoken utterance to be input.

In addition, the method further comprises transmitting a request to reset a buffer of a speech processing system after the signal processing for the first spoken utterance has been suspended.

In order to achieve the aforementioned aspects, a speech recognition method according to an exemplary embodiment of the present disclosure may be configured to comprise receiving a first spoken utterance signal for signal processing, receiving a suspension request signal requesting suspension of signal processing the first spoken utterance signal, suspending signal processing for the first spoken utterance signal based on the signal processing not being completed when the suspension request signal is received, and resetting a buffer for speech processing of signals.

In addition, the method further comprises transmitting a confirmation message confirming that signal processing for the first spoken utterance signal has been suspended.

In addition, the buffer is reset in response to receiving a buffer reset request signal.

In order to achieve the aforementioned aspects, a speech recognition apparatus according to an exemplary embodiment of the present disclosure may be configured to comprise a communication module, a microphone, a speaker and a controller configured to detect an event following a first spoken utterance based on audio received via the microphone, determine whether signal processing has been completed for the first spoken utterance when the event is detected, transmit, via the communication module, a suspension request signal requesting suspension of signal processing for the first spoken utterance based on a determination that the signal processing has not been completed; and switch to a mode for detecting a second spoken utterance based on confirmation that the signal processing for the first spoken utterance has been suspended.

In addition, the controller is further configured to output a notification, via the speaker, that signal processing for the first spoken utterance has been suspended and to request the second spoken utterance to be input.

In addition, the controller is further configured to transmit, via the communication module, a request to reset a buffer of a speech processing system after the signal processing for the first spoken utterance has been suspended.

### BRIEF DESCRIPTION OF THE DRAWINGS

The foregoing and other objectives, features, and advantages of the invention, as well as the following detailed description of the embodiments, will be better understood when read in conjunction with the accompanying drawings. For the purpose of illustrating the invention, there is shown in the drawings an exemplary embodiment that is presently preferred, it being understood, however, that the invention is not intended to be limited to the details shown because various modifications and structural changes may be made therein without departing from the spirit of the invention and within the scope and range of equivalents of the claims. The use of the same reference numerals or symbols in different drawings indicates similar or identical items.

FIG. 1 is an exemplary view of a reutterance process for canceling a spoken utterance according to the related art.

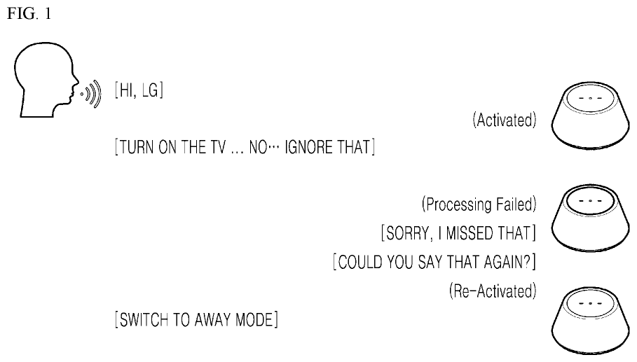

FIG. 2 is an exemplary view of an utterance cancellation process according to an exemplary embodiment of the present disclosure.

FIG. 3 is an exemplary view of a network environment including various smart devices which are capable of functioning as a speech recognition apparatus according to an exemplary embodiment of the present disclosure.

FIG. 4 is a block diagram illustrating a speech processing system according to an exemplary embodiment of the present disclosure.

FIG. 5 is a block diagram of a speech recognition apparatus according to an exemplary embodiment of the present disclosure.

FIG. 6 is an exemplary view illustrating a detection module according to an exemplary embodiment of the present disclosure.

FIG. 7 is a data flowchart of a speech recognition method according to an exemplary embodiment of the present disclosure.

### DETAILED DESCRIPTION OF THE EMBODIMENTS

Hereinafter, exemplary embodiments of the present disclosure will be described in detail with reference to accompanying drawings, and the same or similar elements are designated with the same numeral references regardless of numerals in the drawings and their redundant description will be omitted. As used herein, the suffixes “module,” “unit,” and “part” are used for elements in order to facilitate the disclosure only. Therefore, significant meanings or roles are not given to the suffixes themselves and it is understood that the “module,” “unit,” and “part” can be used together or interchangeably. In describing the exemplary embodiments in the present specification, moreover, the detailed description will be omitted when a specific description for publicly known technologies to which the disclosure pertains is judged to obscure the gist of the exemplary embodiments in the present disclosure. Also, the accompanying drawings are used to help easily understand exemplary embodiments in the present disclosure and it should be understood that the idea of the present disclosure is not limited by the accompanying drawings. The idea of the present disclosure should be construed to extend to any alterations, equivalents, and substitutes in addition to those which are particularly set out in the accompanying drawings.

It will be understood that although the terms first, second and the like may be used herein to describe various elements, these elements should not be limited by these terms. These terms are generally only used to distinguish one element from another.

It will be understood that when an element is referred to as being “connected with” another element, the element can be connected with another element or intervening elements may also be present. In contrast, when an element is referred to as being “directly connected with” another element, there are no intervening elements present.

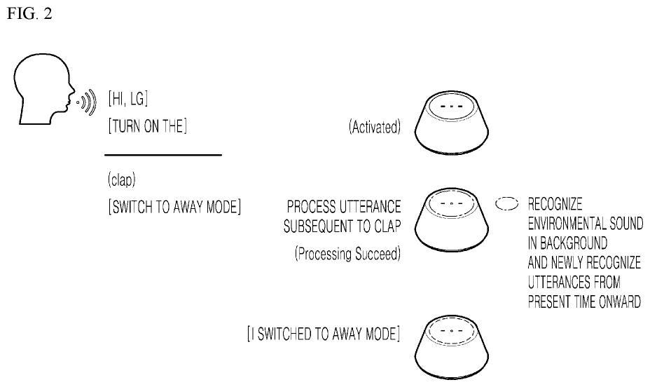

FIG. 2 is an exemplary view of an utterance cancellation process according to an exemplary embodiment of the present disclosure.

Referring to FIG. 2, illustrated is a procedure for canceling an utterance using a speech recognition apparatus 100, namely a smart speaker, for speech recognition according to an exemplary embodiment of the present disclosure. A user initiates a conversation with the smart speaker by speaking a wake-up word of “Hi, LG.” The smart speaker is activated through recognition of the wake-up word.

Next, the user begins to speak a first spoken utterance of “Turn on the TV”, but stops talking before completing the utterance. In this case, the user may speak another utterance intended to cancel the first spoken utterance.

Then, the user claps, and in response to the clap sound, the smart speaker suspends processing of the first spoken utterance, uttered before the clap sound, and emits an LED light which is distinct from the LED light emitted upon initial activation.

Thereafter, the user speaks a second spoken utterance of “Switch to away mode,” and the smart speaker recognizes the second spoken utterance of the user and answers “I have switched to away mode.”

As described above, the speech recognition apparatus 100 for speech recognition according to an exemplary embodiment of the present disclosure may cancel speech signal processing for an utterance uttered prior to a cancellation command, which is a sound (such as a clap sound) that is distinct from general utterances, by detecting the cancellation command, and may enter a ready state such that a new utterance can be detected. In this case, the speech recognition apparatus 100 may indicate, using an LED light, that the speech recognition apparatus 100 is in a state in which an utterance has been cancelled by the cancellation command. The speech recognition apparatus 100 detects environmental sound generated in the background, and newly recognizes utterances from the present time onward.

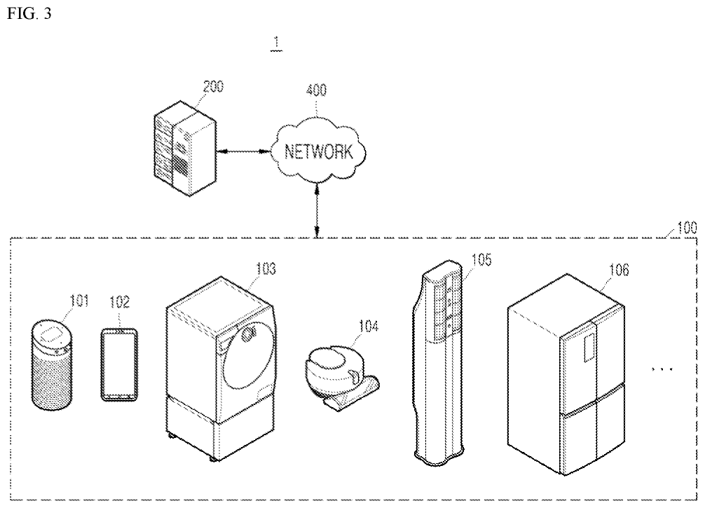

FIG. 3 is an exemplary view of a network environment including various smart devices which are capable of functioning as a speech recognition apparatus according to an exemplary embodiment of the present disclosure.

Referring to FIG. 3, illustrated are various types of speech recognition apparatuses 100 for speech recognition, a speech processing system 200, and a network 400 for connecting the same, according to an exemplary embodiment of the present disclosure.

The speech recognition apparatus 100 may include at least one of a smart speaker 101, a smartphone 102, a smart washer 103, a smart vacuum cleaner 104, a smart air conditioner 105, and a smart refrigerator 106, but is not limited thereto.

The speech processing system 200 receives a speech signal from the speech recognition apparatus 100, and transmits, to the speech recognition apparatus 100, a synthesized speech signal that is generated through speech recognition and natural language processing.

The speech processing system 200 suspends processing of an utterance uttered prior to a cancellation command when the canceling command is detected through the speech recognition apparatus 100. In addition, the speech processing system 200 may reset a buffer of a channel related to the suspension of the corresponding speech recognition processing upon request from the speech recognition apparatus 100 or independently.

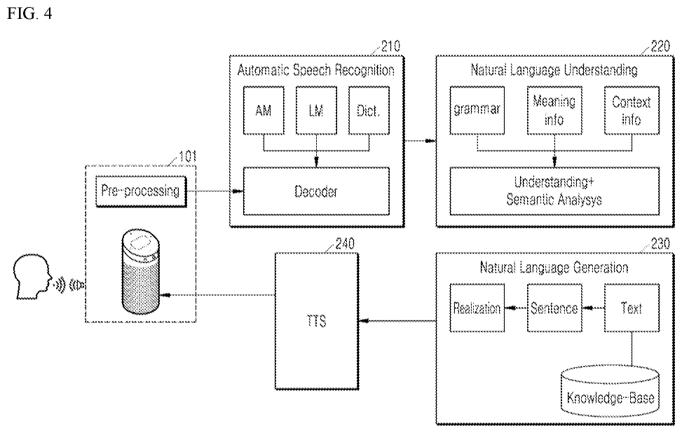

FIG. 4 is a block diagram of a speech processing system according to an exemplary embodiment of the present disclosure.

Referring to FIG. 4, the smart speaker 101 for performing pre-processing and the speech processing system 200 are illustrated. The speech processing system 200 may be configured to include automatic speech recognition 210, natural language understanding 220, natural language generation 230, and text to speech 240.

The speech recognition 210 recognizes speech data or the meaning of a speech feature vector, which is generated through pre-processing, by using an acoustic model, a language model, and various dictionaries, such as an acoustic dictionary. A decoder, namely, a speech recognition engine, may be used for speech recognition. The speech recognition engine may recognize speech by using various methods, such as probability theory and artificial intelligence.

The natural language understanding 220 understands and analyzes the meaning of recognized speech by using grammar, meaning information, and context information.

The natural language generation 230 writes text by using a knowledge base on the basis of the analyzed meaning, and formulates and produces a sentence.

The text to speech 240 synthesizes the produced sentence into speech by using a speech synthesis engine.

Lastly, the smart speaker 101 outputs the synthesized speech signal as audio.

The speech processing system 200 may include a plurality of servers for each function, and the plurality of servers may be processed in parallel for one function. In addition, the speech processing system 200 may include a separate central control server for controlling the respective functions.

Speech recognition technology is divided into model learning and recognition using learned models, wherein a technology of learning an acoustic model and a language model represents the core technology of speech recognition.

An artificial intelligence algorithm may be utilized in the process of learning the acoustic model and the language model, and the process of speech synthesis.

Unlike in video processing, the type of raw data in speech data analysis is one-dimensional data, and speech data analysis has a time-series characteristic. Accordingly, a deep learning method for time-serial processing is commonly utilized in speech data analysis.

Deep learning may be applied in a speech data analysis method that is performed according to a time-serial processing method using a recurrent neural network (RNN) structure. An RNN structure is a configuration in which a loop is added to an existing hidden layer. RNN may be utilized not only for speech recognition but also for natural language processing.

As opposed to speech recognition, speech synthesis is a technology for converting text into a speech signal. In speech synthesis, speech may be synthesized in sample units by using deep learning.

Other audio analysis technologies utilizing deep learning include drum transcription and automatic tagging technologies.

The network 400 may be any suitable communication network, including a local area network (LAN), a wide area network (WAN), the Internet, an intranet, an extranet, a mobile network such as cellular, 3G, and LTE, a WiFi network, and an ad hoc network, or a combination thereof.

The network 400 may include connection of network elements, such as hubs, bridges, router, switches, and gateways. The network 400 may include a multi-network environment, namely one or more connected networks including public networks, such as the Internet, and private networks, such as a secure enterprise private network. Access to the network 400 may be provided via one or more wired or wireless access networks.

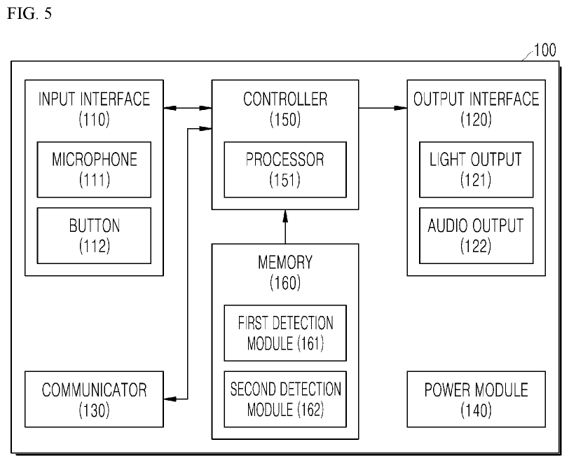

FIG. 5 is a block diagram of a speech recognition apparatus according to an exemplary embodiment of the present disclosure.

Referring to FIG. 5, the speech recognition apparatus 100 for speech recognition according to an exemplary embodiment of the present disclosure may be configured to include an input interface 110, an output interface 120, a communicator 130, a power module 140, a controller 150, and a memory 160.

The input interface 110 and the output interface 120 serve as interfaces with various external devices that can be coupled to the speech recognition apparatus 100.

The input interface 110 includes a microphone 111, which converts speech into a speech signal, and a button 112 for controlling volume and which has a start function. In addition, the input interface 110 may include any of wired or wireless data ports, memory card ports, audio input ports, and video input ports.

The output interface 120 includes a light output 121 and an audio output 122.

The light output 121 may indicate the state of the speech recognition apparatus 100 using LEDs of different colors. For example, the light output 121 may distinguish a state in which the speech recognition apparatus 100 has been activated by the wake-up word, a state in which an utterance has been cancelled by the cancellation command, and a state of having outputted speech processing results, using a different colored LED to indicate each different state.

The audio output 122 may output synthesized speech by using an acoustic device, such as a speaker. In addition, the output interface 120 may include any of wired or wireless headset ports, wired or wireless data ports, ports for coupling a device provided with an identification module, audio output ports, video output ports, and earphone ports.

The communicator 130 is a device for connecting the speech recognition apparatus 100 to the network 400, which includes wireless communication networks such as 3G, 4G, and 5G networks, and the Internet, in order to transmit and receive data. The speech recognition apparatus 100 may transmit and receive text data and speech data by using the communicator 130. The communicator 130 may be configured to include, for example, at least one of various wireless Internet modules, a short-range communication module, a GPS module, and a modem for mobile communication.

The wireless Internet module is a module for wireless Internet connection. The wireless Internet module is configured to transmit and receive a wireless signal in a communication network according to wireless Internet technologies.

The wireless Internet technology may include, for example, Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and the like.

The short-range communication module may support short range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies.

The power module 140 may include secondary batteries, circuitries for charge and discharge, and external charger ports.

The controller 150 may include a processor 151. The processor 151 may control the input interface 110, the output interface 120, the communicator 130, and the power module 140, and may control detection of utterances and cancellation commands of the user via detection modules stored in the memory 160.

The processor 151 performs pre-processing for inputted speech. For example, an utterance and the environmental sound corresponding to the cancellation command, such as the clap sound and the finger snap sound, or a pre-registered spoken cancellation command, distinct from the utterance, are converted into audio signals via the microphone 111. The processor 151 converts the audio signals into digital signals through a sampling process. The processor 151 may perform pre-processing to remove noise from the digital signal, excluding the speech of the user and the recognized cancellation command.

The memory 160 may be configured to include a first detection module 161 and a second detection module 162. The first detection module 161 detects general utterances spoken by the user, including the wake-up word. The second detection module 162 may detect the clap sound or finger snap sound which corresponds to the cancellation command, or the pre-registered spoken cancellation command.

When the cancellation command is detected, the corresponding cancellation command is excluded as a target for speech processing. That is, the speech recognition apparatus 100 does not transmit the signal corresponding to the cancellation command to the speech processing system 200. Accordingly, since the cancellation command is excluded as a target for signal processing, the speech recognition apparatus 100 is capable of immediately requesting cancellation of a spoken utterance. The cancellation request may correspond to a command for suspending an operation being performed by a processor of the speech processing system 200.

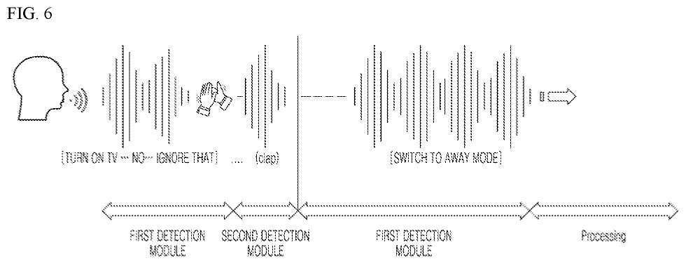

FIG. 6 is an exemplary view illustrating a detection module according to an exemplary embodiment of the present disclosure.

Referring to FIGS. 5 and 6, illustrated are a procedure of a first spoken utterance uttered by the user and a procedure of canceling the first spoken utterance by means of the clap sound. With regard to the detection modules, the first spoken utterance and the clap sound may be detected by the first detection module 161, which detects the content of utterances including the wake-up word, and the second detection module 162, which detects the cancellation command. In addition to the clap sound, a finger snap sound or a registered spoken utterance than the wake-up word, such as “Cancel,” may be used as a cancellation command.

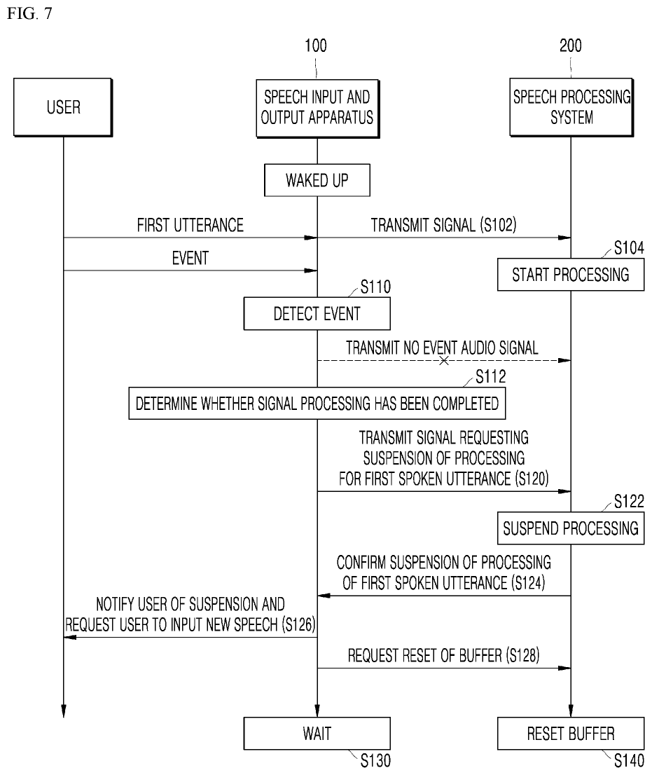

FIG. 7 is a data flowchart of a speech recognition method according to an exemplary embodiment of the present disclosure.

Referring to FIG. 7, a speech recognition method for speech recognition S100 according to an exemplary embodiment of the present disclosure may be configured to include steps S102 to S140.

First, the user may speak the wake-up word. The speech recognition apparatus 100 is activated by detection of the wake-up word, and in some cases, followed by a first spoken utterance. Then, the uttered wake-up word with the first spoken utterance is transmitted to the speech processing system 200 by being converted into a speech signal (S102).

Next, the speech recognition apparatus 100 detects an event corresponding to either of a registered spoken utterance other than the wake-up word and a frictional sound having a specific frequency range, which are generated during or after the first spoken utterance. Here, the event corresponds to the cancellation command. The user may use the cancellation command to cancel the utterance which has been spoken but not yet processed.

The detected event, namely the audio signal corresponding to the cancellation command, is not transmitted to the speech processing system.

The detection of the cancellation command may be performed by the second detection module 162. The first detection module 161 detects general utterances spoken by the user, including the wake-up word.

The second detection module 162 detects the cancellation command. When the cancellation command is a registered spoken utterance of the user, the second detection module 162 may detect the corresponding cancellation command by using feature vectors representing the phonemic characteristics corresponding to the pre-stored cancellation command.

When the cancellation command is an environmental sound, such as a frictional sound caused by a clap or a finger snap, the second detection module 162 may detect the frictional sound having a frequency range that is distinct from that of human speech.

Next, the speech recognition apparatus 100 determines whether the signal processing for the first spoken utterance has been completed at the point in time when the event, that is, the cancellation command, is detected (S112). Specifically, the speech recognition apparatus 100 may determine whether the signal processing has been completed according to the presence or absence of a received synthesized speech signal. Accordingly, if no synthesized speech signal has been received, the speech signal for the first spoken utterance has not been processed.

When the signal processing for the first spoken utterance has not been completed at the point in time when the event is detected, the speech recognition apparatus 100 transmits, to the speech processing system 200, the suspension request signal requesting suspension of the signal processing for the first spoken utterance (S120).

The suspension request signal corresponds to a signal requesting suspension of at least one of speech recognition, understanding of the content of the recognized speech, generation of a response to the understood content, and conversion of the generated response into speech.

Referring to FIG. 4, when the first spoken utterance of the user, which is the target of cancellation, is not canceled, the first spoken utterance goes through the processes of speech recognition, natural language understanding, natural language generation, and speech synthesis. The speech recognition apparatus 100 may request suspension of speech processing for each process.

In response to the speech processing suspension request, the speech processing system 200 suspends speech signal processing for the first spoken utterance to be canceled (S122).

The speech recognition apparatus 100 may receive a confirmation message regarding the suspension of the signal processing for the first spoken utterance (S124). On the basis of the confirmation message, the speech recognition apparatus 100 may proceed to perform the next process.

The speech recognition apparatus 100 may notify a user that the speech signal processing for the first spoken utterance has been suspended, and may request the user to input new speech (S126). For example, the speech recognition apparatus 100 may request the user to speak a second utterance by saying “Your former request has been canceled” and “How can I help?” In this case, the user can immediately start speaking the second utterance, without first speaking the wake-up word.

In addition, the speech recognition apparatus 100 may request the speech processing system 200 to reset the buffer of the channel related to the speech signal processing for the first spoken utterance (S128). In response to the buffer reset request, the speech processing system 200 may perform buffer reset (S140). According to the reset, data related to the first spoken utterance is deleted from the buffer, and thus, the speech processing system 200 may wait to process the second spoken utterance in a state in which sufficient buffer space has been secured.

Having suspended the speech signal processing for the first spoken utterance, the speech recognition apparatus 100 may wait to recognize the second spoken utterance of the user (S130).

The above-described speech recognition method according to an exemplary embodiment of the present disclosure can be implemented in a program recorded medium as computer-readable codes. The computer-readable media may include all kinds of recording devices in which data readable by a computer system are stored. The computer-readable media may include a hard disk drive (HDD), a solid state disk (SSD), a silicon disk drive (SDD), ROM, RAM, CD-ROM, magnetic tapes, floppy discs, optical data storage devices, and the like. In addition, the computer may include the processor 151 of the speech recognition apparatus 100.

As described above, according to an exemplary embodiment of the present disclosure, by canceling an erroneously spoken utterance, a speech recognition process can proceed rapidly.

Moreover, since the erroneously uttered speech is cancelled before being processed, an unnecessary waste of resources may be prevented.

While the disclosure has been explained in relation to its preferred embodiments, it is to be understood that various modifications thereof will become apparent to those skilled in the art upon reading the specification. Therefore, it is to be understood that the disclosure disclosed herein is intended to cover such modifications as fall within the scope of the appended claims.

What is claimed is:

1. A speech recognition method comprising:
detecting an event based on audio received following a first spoken utterance;
determining whether signal processing has been completed for the first spoken utterance when the event is detected;
transmitting a suspension request signal requesting suspension of signal processing for the first spoken utterance based on a determination that the signal processing has not been completed; and
switching to a mode for detecting a second spoken utterance based on confirmation that the signal processing for the first spoken utterance has been suspended.

2. The method according to claim 1, wherein the event comprises an utterance that is distinct from a wake-up word.

3. The method according to claim 1, wherein the event comprises a sound having a specific frequency range.

4. The method according to claim 1, wherein the signal processing comprises speech recognition, natural language understanding, natural language generation, and speech synthesis, and the suspension request signal corresponds to a signal requesting suspension of at least one of the speech recognition, natural language understanding, natural language generation, or speech synthesis.

5. The method according to claim 1, wherein the event to be detected for suspending signal processing is designated by a user.

6. The method according to claim 1, wherein an audio signal corresponding to the detected event is not transmitted to a speech processing system.

7. The method according to claim 1, further comprising receiving a confirmation message confirming that signal processing for the first spoken utterance has been suspended.

8. The method according to claim 1, further comprising outputting a notification that the signal processing for the first spoken utterance has been suspended, and requesting the second spoken utterance to be input.

9. The method according to claim 1, further comprising transmitting a request to reset a buffer of a speech processing system after the signal processing for the first spoken utterance has been suspended.

10. A speech recognition method comprising:
receiving a first spoken utterance signal for signal processing;
receiving a suspension request signal requesting suspension of signal processing the first spoken utterance signal;
suspending signal processing for the first spoken utterance signal based on the signal processing not being completed when the suspension request signal is received; and
resetting a buffer for speech processing of signals.

11. The method according to claim 10, further comprising transmitting a confirmation message confirming that signal processing for the first spoken utterance signal has been suspended.

12. The method according to claim 10, wherein the buffer is reset in response to receiving a buffer reset request signal.

13. A speech recognition apparatus comprising:
a communication module;
a microphone;
a speaker; and
a controller configured to:
detect an event following a first spoken utterance based on audio received via the microphone;
determine whether signal processing has been completed for the first spoken utterance when the event is detected;
transmit, via the communication module, a suspension request signal requesting suspension of signal processing for the first spoken utterance based on a determination that the signal processing has not been completed; and
switch to a mode for detecting a second spoken utterance based on confirmation that the signal processing for the first spoken utterance has been suspended.

14. The apparatus according to claim 13, wherein the controller is further configured to output a notification, via the speaker, that signal processing for the first spoken utterance has been suspended and to request the second spoken utterance to be input.

15. The apparatus according to claim 13, wherein the controller is further configured to transmit, via the communication module, a request to reset a buffer of a speech processing system after the signal processing for the first spoken utterance has been suspended.
